(19) United States
(12) Patent Application Publication
(10) Pub. No.: US 2009/0126645 A1
(43) Pub. Date: May 21, 2009

(54) Dirt collecting device for aquarium

(76) Inventor: Hsueh Lee Tsai, Yunlin Hsien (TW)

Correspondence Address: CHARLES E. BAXLEY, ESQUIRE, 90 JOHN STREET, SUITE 309, NEW YORK, NY, 10038, US

(21) Appl. No.: 11/986,431

(22) Filed: Nov. 21, 2007

(51) Int. Cl. A01K 63/04

(52) U.S. Cl. 119/261; 119/259

(57) ABSTRACT

A dirt collecting device for an aquarium includes a housing disposed on an apertured floor plate, a barrel disposed on the housing, a casing disposed on the barrel and having one or more openings for allowing the water form the barrel to flow into the aquarium, the casing includes a tubular member for forming an annular chamber between the tubular member and the casing, and an exit communicating with the annular chamber of the casing, and an air supplying device may supply air bubbles into the housing to carry the dirt and to move the dirt upwardly over the tubular member and collected in the annular chamber of the casing for allowing the dirt to be easily removed.

### BACKGROUND OF THE INVENTION

1. Field of the Invention

The present invention relates to a dirt collecting device for an aquarium, and more particularly to a dirt collecting device for attaching to an aquarium and for suitably agitating the water and for suitably filtering and collecting the dirt contained within the water of the container.

2. Description of the Prior Art

Typical aquarium facilities comprise a pump disposed in a chamber of a container for circulating the water contained within the container and for pumping fresh air or carbon dioxide into the container and thus for airing or aerating purposes, and one or more filters disposed in the container for filtering the water and for removing the dirt from the water.

For example, U.S. Pat. No. 4,186,093 to Willinger discloses one of the typical aquarium bottom filtering apparatuses comprising a container having a filtration compartment which converts the contaminated water into decontaminated water with a filtering material.

However, the filtering material may have the dirt contained therein and the dirt may not be easily cleaned or removed from the container.

U.S. Pat. No. 4,295,965 to Koster discloses another typical multi-filter chamber aquarium filter comprising several similarly constructed filter cassettes located above each other, and each including two filter chambers having a polyester fiber fleece, a quartz gravel, or a polyester wool for filtering purposes.

However, similarly, the dirt may be filtered and contained within the polyester fiber fleece, the quartz gravel, or the polyester wool and the dirt also may not be easily cleaned or removed from the container or the filter cassettes.

U.S. Pat. No. 4,753,723 to Willinger discloses a further typical inside filter for aquarium comprising a platform, and a filtration chamber above the platform for receiving a filtration material.

However, the user may not know when will the filtration material be contaminated with the dirt and when the filtration material may no longer be used, and the user may not know when the filtration material is required to be cleaned or removed from the container.

U.S. Pat. No. 4,802,980 to Gilkey et al. discloses a still further typical aquarium filter comprising a tube connected to a filtration device which contains a charcoal and fibrous filter material for a secondary filtering of the aquarium water, and the secondary charcoal and fibrous filter material is contained with a disposable portion of the upwardly extending tube.

However, the user may not know when will the secondary charcoal and fibrous filter material be contaminated with the dirt and when the secondary charcoal and fibrous filter material may no longer be used, and the user may not know when the secondary charcoal and fibrous filter material is required to be cleaned or removed from the container.

U.S. Pat. No. 4,957,623 to Henzlik discloses a still further typical aquarium cleaning system comprising a cylindrical filtration cartridge for receiving a filter medium, such as activated charcoal or the like.

However, the user also may not know when the filter material will be contaminated with the dirt and when the filter material may no longer be used, and the user may not know when the filter material is required to be cleaned or changed or removed from the container.

The present invention has arisen to mitigate and/or obviate the afore-described disadvantages of the conventional dirt collecting devices for aquarium facilities.

### SUMMARY OF THE INVENTION

The primary objective of the present invention is to provide a dirt collecting device for attaching to an aquarium and for suitably agitating the water and for suitably filtering and collecting the dirt contained within the water of the container.

In accordance with one aspect of the invention, there is provided a dirt collecting device for an aquarium comprising a floor plate including a compartment formed within an outer peripheral wall, and including a plurality of apertures formed therein for allowing a dirt in the aquarium to flow through the apertures of the floor plate and to flow into the compartment of the floor plate, a housing disposed on the floor plate and including a space formed therein and communicating with the compartment of the floor plate for allowing the water to flow from the compartment of the floor plate into the space of the housing, a barrel disposed on the housing, a casing disposed on the barrel and including at least one opening formed therein for allowing the water form the barrel to flow into the aquarium, the casing including a tubular member extended therein for forming an annular chamber between the tubular member and the casing, and having an exit formed therein and communicating with the annular chamber of the casing, and an air supplying device for supplying air bubbles into the space of the housing to carry the dirt and to move the dirt upwardly over the tubular member and to be collected in the annular chamber of the casing.

The air supplying device includes an air stone disposed in the housing for generating the air bubbles. The air supplying device includes a pumping device coupled to the air stone with a hose for supplying an air to the air stone.

The casing includes a filter material disposed in the casing and aligned with the opening of the casing for filtering and separating the dirt from the water and for preventing the dirt from flowing into the aquarium again.

The casing includes a cover disposed on top of the casing to selectively close the casing. The casing includes at least one air port formed therein for allowing the air to flow into or out of the casing. The casing includes at least one orifice formed therein also for allowing the air to flow into or out of the casing or for engaging the hose into the casing.

The casing includes a pipe coupled to the exit for collecting the dirt in the annular chamber of the casing. The floor plate includes at least one latch provided on top, and the casing includes at least one catch for engaging with the latch and for detachably attaching the housing to the floor plate.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a cross sectional view illustrating the operation of a dirt collecting device in accordance with the present invention;

FIG. 2 is an exploded view of the dirt collecting device;

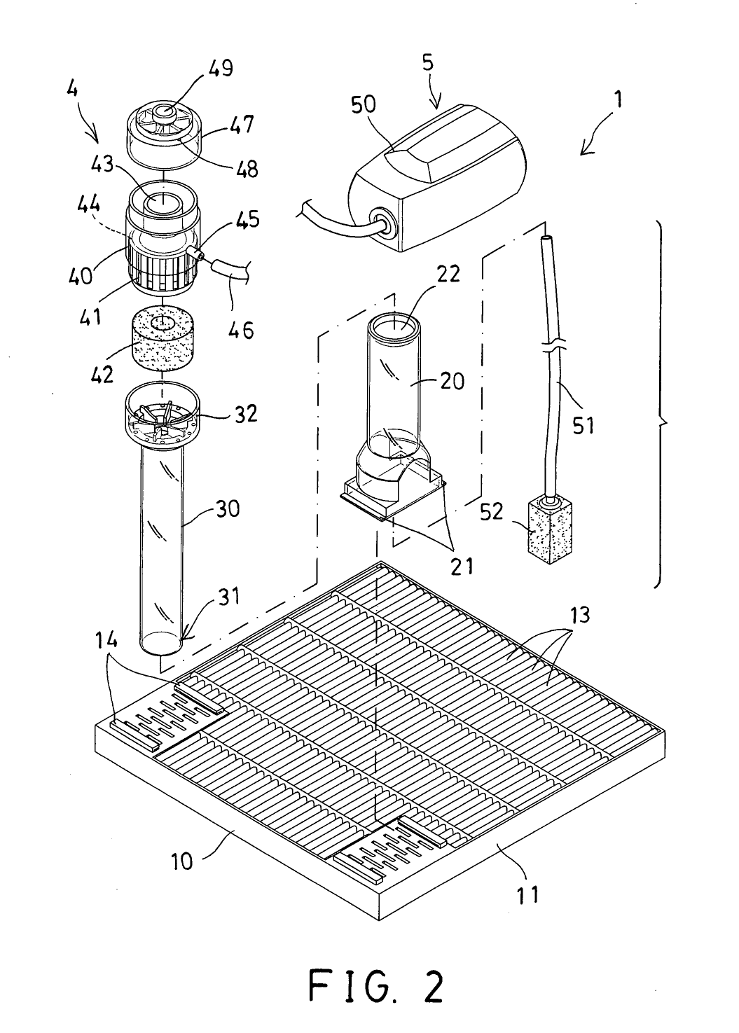

FIG. 3 is a perspective view of the dirt collecting device; and

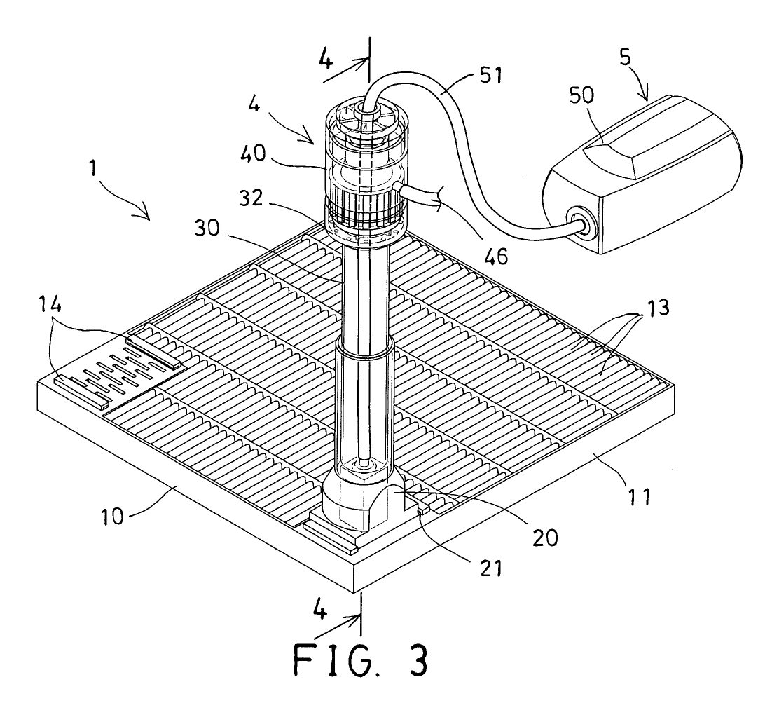

FIG. 4 is a cross sectional view of the dirt collecting device taken along lines 4-4 of FIG. 3.

### DETAILED DESCRIPTION OF THE PREFERRED EMBODIMENT

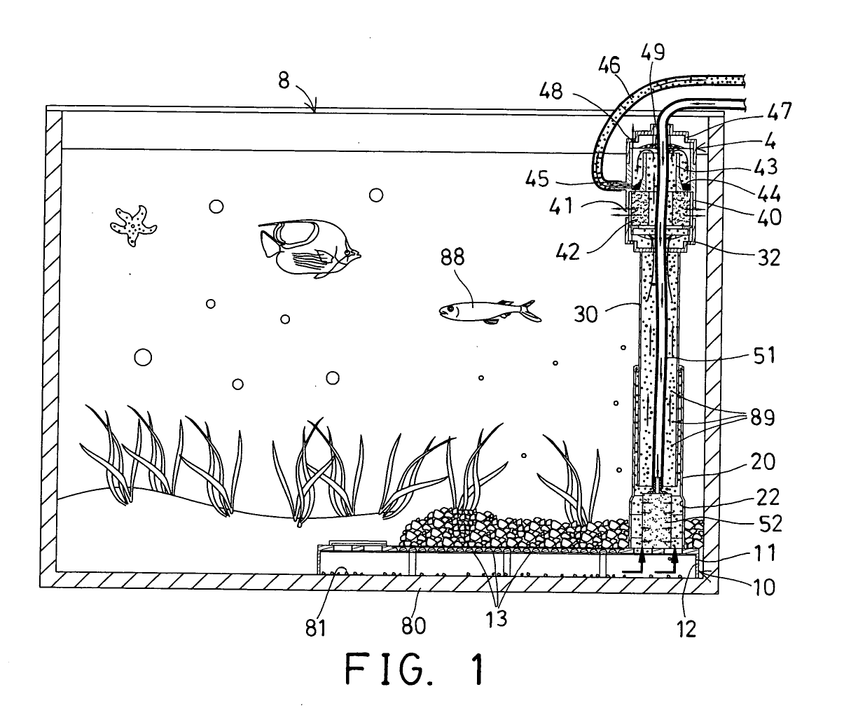

Referring to the drawings, and initially to FIG. 1, a dirt collecting device 1 in accordance with the present invention is provided for attaching to an aquarium 8 which comprises a container 80 including a chamber 81 formed therein for receiving water and fish 88, and comprises an apertured gravel-supporting floor plate 10 including a compartment 12 formed within an outer peripheral wall 11, and including a number of apertures 13 formed in the upper portion thereof, and including one or more (such as two or two pairs of) rails or latches 14 provided on the upper portion thereof for detachably attaching or securing a housing 20 which includes one or more (such as two or two pairs of) catches 21 for engaging with the latches 14 and thus for detachably attaching or securing the housing 20 to top or the upper portion of the floor plate 10.

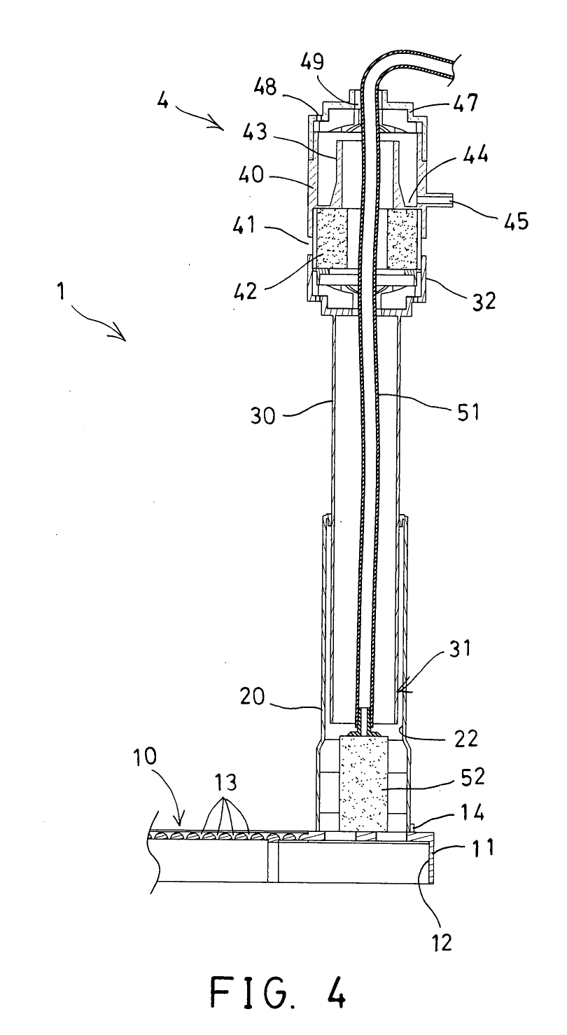

As shown in FIGS. 1 and 4, the housing 20 includes a hollow interior or space 22 formed therein and communicating with the compartment 12 of the floor plate 10 for allowing the water in the chamber 81 of the container 80 to flow through the apertures 13 of the floor plate 10 and to flow into the compartment 12 of the floor plate 10 and then to flow into the space 22 of the housing 20. It is to be noted that the dirt and/or the protein in the chamber 81 of the container 80 may be dropped and engaged through the apertures 13 of the floor plate 10 and then engaged into the compartment 12 of the floor plate 10, and may then be carried by the water to flow into the space 22 of the housing 20. A barrel 30 includes a lower portion 31 engaged into the space 22 of the housing 20 or disposed on the housing 20, and includes a sleeve 32 formed or provided on top or on the upper portion thereof.

A dirt or protein separating device 4 includes a casing 40 attached or disposed on or in the sleeve 32 of the barrel 30, includes one or more openings 41 formed therein for allowing the water form the barrel 30 to flow into the chamber 81 of the container 80 again. A filter sponge or member or material 42 may be disposed in the casing 40 and aligned with the openings 41 of the casing 40 for filtering the water and for separating the dirt and/or the protein from the water and thus for preventing the filtered dirt or protein from flowing into the chamber 81 of the container 80 again. The casing 40 includes a tubular member 43 extended in such as the upper portion thereof for forming an annular chamber 44 between the tubular member 43 and the casing 40, and includes an exit 45 formed therein and communicating with the lower portion of the annular chamber 44 and coupled to a pipe 46.

A cover 47 is openably disposed or attached on top of the casing 40 to selectively close the casing 40, and may include one or more air ports 48 formed or provided in such as the upper portion of the casing 40 or formed in the cover 47 for allowing the air to flow into or out of the casing 40, and may include one or more orifices 49 formed or provided in such as the upper portion of the casing 40 or formed in the cover 47. An air pumping or supplying means or device 5 is further provided and includes a pumping device 50 coupled to an air stone 52 with a hose 51 which may be engaged through the orifices 49 of the casing 40 and engaged through the casing 40 and the barrel 30, and the air stone 52 is located below the barrel 30 and/or disposed or engaged in the housing 20 for allowing the air pumped by the air pumping device 50 to flow out of the air stone 52 and into the housing 20 as air bubbles 89 which may flow upwardly through the barrel 30 and then may flow into the casing 40.

In operation, as shown in FIG. 1, the dirt and/or the protein in the chamber 81 of the container 80 may be dropped and engaged through the apertures 13 of the floor plate 10 and then engaged into the compartment 12 of the floor plate 10, and may then be carried by the water to flow into the space 22 of the housing 20 by the air bubbles 89, and may then flow upwardly through the barrel 30 and then may flow into the casing 40, the air bubbles 89 and the dirt and/or the protein contained or carried by the air bubbles 89 may be forced to move over the tubular member 43 and may be collected in the lower portion of the annular chamber 44 of the casing 40, and may then be drawn or vacuumed or sucked out through the hose 46 and to be collected in a tank (not shown) or the like.

The air bubbles 89 may flow out through the air ports 48 and/or the orifices 49 of the casing 40 and/or of the cover 47, and the dirt and/or the protein contained or carried by the air bubbles 89 may thus be forced to move over the tubular member 43 and may be suitably collected in the lower portion of the annular chamber 44 of the casing 40 by the upwardly flowing air bubbles 89. The water may flow through the filter sponge or member or material 42 which may separate the dirt and/or the protein from the water and thus may prevent the filtered dirt or protein from flowing into the chamber 81 of the container 80 again.

Accordingly, the dirt collecting device in accordance with the present invention may be provided for attaching to an aquarium and for suitably filtering and collecting the dirt and/or the protein contained within the water of the container.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A dirt collecting device for an aquarium comprising:
a floor plate including a compartment formed within an outer peripheral wall, and including a plurality of apertures formed therein for allowing a dirt in the aquarium to flow through said apertures of said floor plate and to flow into said compartment of said floor plate,
a housing disposed on said floor plate and including a space formed therein and communicating with said compartment of said floor plate for allowing the water to flow from said compartment of said floor plate into said space of said housing,
a barrel disposed on said housing,
a casing disposed on the barrel and including at least one opening formed therein for allowing the water form said barrel to flow into the aquarium, said casing including a tubular member extended therein for forming an annular chamber between said tubular member and said casing, and having an exit formed therein and communicating with said annular chamber of said casing, and
means for supplying air bubbles into said space of said housing to carry the dirt and to move the dirt upwardly over said tubular member and collected in said annular chamber of said casing.

2. The dirt collecting device as claimed in claim 1, wherein said air supplying means includes an air stone disposed in said housing for generating the air bubbles.

3. The dirt collecting device as claimed in claim 2, wherein said air supplying means includes a pumping device coupled to said air stone with a hose for supplying an air to said air stone.

4. The dirt collecting device as claimed in claim 1, wherein said casing includes a filter material disposed in said casing and aligned with said at least one opening of said casing for filtering and separating the dirt from the water and for preventing the dirt from flowing into the aquarium again.

5. The dirt collecting device as claimed in claim 1, wherein said casing includes a cover disposed on top of said casing to selectively close said casing.

6. The dirt collecting device as claimed in claim 5, wherein said casing includes at least one air port formed therein for allowing the air to flow into or out of said casing.

7. The dirt collecting device as claimed in claim 5, wherein said casing includes at least one orifice formed therein.

8. The dirt collecting device as claimed in claim 1, wherein said casing includes a pipe coupled to said exit for collecting the dirt in said annular chamber of said casing.

9. The dirt collecting device as claimed in claim 1, wherein said floor plate includes at least one latch provided on top, and said casing includes at least one catch for engaging with said at least one latch and for detachably attaching said housing to said floor plate.
